(19) United States
(12) Patent Application Publication
(10) Pub. No.: US 2003/0002551 A1
(43) Pub. Date: Jan. 2, 2003

(54) Laser diode driver

(75) Inventors: Youngwoo Kwon, Chino Hills, CA (US); Jinho Jeong, Seoul (KR)

Correspondence Address: KOPPEL & JACOBS, Suite 107, 555 St. Charles Drive, Thousand Oaks, CA, 91360, US

(73) Assignee: BROADBAND TRANSPORT TECHNOLOGIES, INC.

(21) Appl. No.: 09/896,603

(22) Filed: Jun. 29, 2001

(51) Int. Cl. H01S 3/00

(52) U.S. Cl. 372/38.02

(57) ABSTRACT

A laser diode driver circuit uses transconductance amplifying devices, preferably FETs, in a balanced input configuration. First and second amplifying devices are arranged to receive respective inverting and non-inverting input signals on their respective control terminals (gates). The amplifying devices are arranged to drive a laser diode connected between the current output terminals (source terminals) of said first and second amplifying devices. In one embodiment, a first node connects a source terminal of a first amplifier FET, a first terminal of the laser diode, and a drain terminal of a biasing FET. In another embodiment, in addition to the circuitry of the first embodiment a second node connects the second amplifier FET, a drain of a second biasing FET, and a second terminal of the laser diode. Preferably, the first and (optionally) the second biasing FETs bias the circuit's outputs with an offset, relative to one another, of substantially the turn-on threshold of the laser diode. The invention provides fast transitions with low power consumption.

### BACKGROUND OF THE INVENTION

1. Field of the Invention

This invention relates to electro-optics and optical communications generally and more specifically to electronic driver circuits for modulated laser diodes.

2. Description of the Related Art

Fiber optic communication systems such as the “Synchronous Optical Network” (SONET) commonly employ electro-optic transponders which translate signals from electrical to optical (and vice-versa). A typical fiber optic communication system might include a fiber transmission medium with multiple nodes at each of which a transponder launches and receives optical data and provides a data interface to electronic systems. To provide the appropriate optical/electronic data interface, transponders commonly include both an optical transmitter and an optical receiver in the same package.

Currently, the semiconductor laser diode is the most prevalent device used in transponders in the transmitter section to directly convert electronic signals into pulses of light.

A suitable electronic driver circuit is required to modulate or switch a laser diode in a transponder circuit. Such a laser diode driver should preferably have fast rise and fall times and low power dissipation. In addition, the driver should provide clean switching of the laser diode: no distortion or spurious content should be introduced into the optical signal (for example, from power supply line fluctuation). Furthermore, a laser diode driver circuit should preferably be relatively simple, economical, and operable from readily available power supply levels.

A typical prior laser-diode driver circuit is shown in FIG. 1. A differential pair of transistors Q_{diff1} and Q_{diff2} is driven by a differential drive input (₊Vin and −Vin). The differential pair is biased by a current source I_{source} in the common “tail” of the emitter circuit, in the well known differential amplifier configuration. Typically the current source includes at least two transistors in a “current mirror” or similar configuration. The laser diode is connected in the collector circuit of one of the transistors (Q_{diff2} in FIG. 1). Typically such driver circuits are supplied in an open collector configuration, so that the laser diode LD is required to be connected via a pin out 2 as shown. Optionally, a current limiting resistor Rₗᵢₘᵢₜ can be interposed between the supply voltage VCC and the laser diode LD.

Although the prior circuit shown in FIG. 1 is adequate for many applications, it consumes power at an undesirably high rate, in part because of the large number of transistors (including multiple transistors included in the tail current source) . The typical driver circuit can be viewed as a switched current source with fairly high output impedance. Since laser diode impedance levels are relatively low (less than 10 ohms, typically), a high mismatch between the driver and load impedance levels exists. In order to reduce ringing and waveform distortion problems associated with the mismatch, a matching resistor is placed off-chip in series with the laser diode to provide a better matched load to the driver. The matched load, of course, comes at the price of useless dissipation of power.

### SUMMARY OF THE INVENTION

In view of the above problems, the present invention is a simple, economical laser diode driver circuit which provides fast switching times while maintaining a clean optical output, notwithstanding substantial power supply fluctuations. A key improvement provided by the present invention is the ability to drive low impedance loads directly without the need for external matching resistors which can greatly increase the power dissipation in transponder systems.

The circuit of the invention includes an amplifier having inverting and non-inverting inputs and inverted and non-inverted outputs arranged to drive a laser diode connected between the inverted and the non-inverted outputs.

The driver circuit uses transconductance amplifying devices, preferably FETs, in a balanced input configuration. First and second amplifying devices are arranged to receive respective inverting and non-inverting input signals on their respective control terminals (gates). The amplifying devices are arranged to drive a laser diode connected between the current output terminals (source terminals) of said first and second amplifying devices. In one embodiment, a first node connects a source terminal of a first amplifier FET, a first terminal of the laser diode, and a drain terminal of a biasing FET. In another embodiment, in addition to the circuitry of the first embodiment a second node connects the second amplifier FET, a drain of a second biasing FET, and a second terminal of the laser diode. Preferably, the first and (optionally) the second biasing FETs bias the circuit's outputs with an offset, relative to one another, of substantially the turn-on threshold of the laser diode.

These and other features and advantages of the invention will be apparent to those skilled in the art from the following detailed description of preferred embodiments, taken together with the accompanying drawings, in which:

### BRIEF DESCRIPTION OF THE DRAWINGS

FIG. 1 is a schematic diagram of a prior art laser diode driver circuit;

FIG. 2 is a block level schematic of a laser diode circuit in accordance with the invention;

FIG. 3 is a component level schematic diagram of one embodiment in accordance with the invention;

FIG. 4a is a graph of voltage versus time, showing typical voltage inputs Vin1 and Vin2 in the circuit of FIG. 3, representative of a balanced 5 Gigahertz square wave input;

FIG. 4b shows the time variation of the current through the laser diode of FIG. 3, in response to the input shown in FIG. 4a, for a variety of supply voltages;

FIG. 4c shows the response of the circuit of FIG. 3 when excited by the input of FIG. 4a, under the condition of an induced supply voltage (V_{dd}′) fluctuation of 0.2 V. (peak-to-peak);

FIG. 4d shows the corresponding response of the circuit of FIG. 3 under the condition of an increased supply voltage (V_{dd}′) fluctuation of 0.4 V. (peak-to-peak);

FIG. 4e shows the superimposition of the waveforms of FIGS. 4c and 4d, to allow convenient comparison;

FIG. 5 is a graph of the frequency response of the circuit of FIG. 3, with amplitude graphed on a linear scale and frequency on a logarithmic scale;

FIG. 6 is a schematic diagram of an alternate embodiment of a driver circuit in accordance with the invention;

FIG. 7 is a schematic diagram of a multistage laser diode driver circuit which incorporates an output stage in accordance with the invention;

FIG. 8a is an accumulated response “eye diagram” which graphs output current (in amperes) as a function of time (in picoseconds) for the simulated circuit of FIG. 7 when driven by a pseudorandom binary excitation at a 10 Gigabit per second rate, where 0.2 nanohenries of bond lead inductance have been assumed associated with the each bond lead of the laser diode; and

FIG. 8b. is another “eye diagram” obtained under circumstances analogous to FIG. 8a, with the single difference that no bond lead inductance has been assumed.

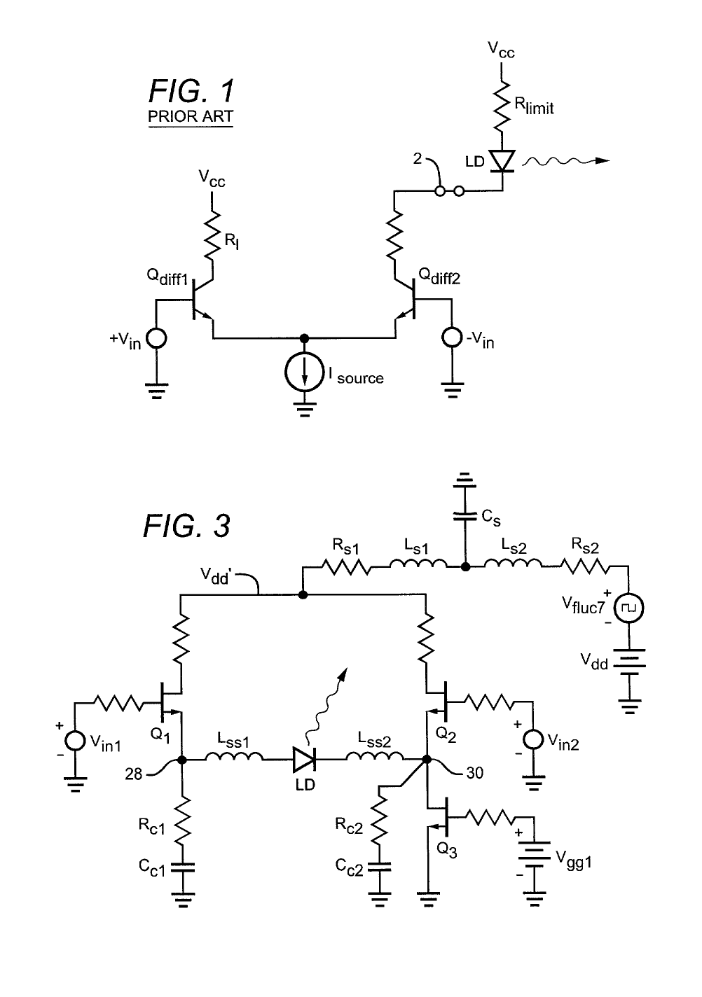

### DETAILED DESCRIPTION OF THE INVENTION

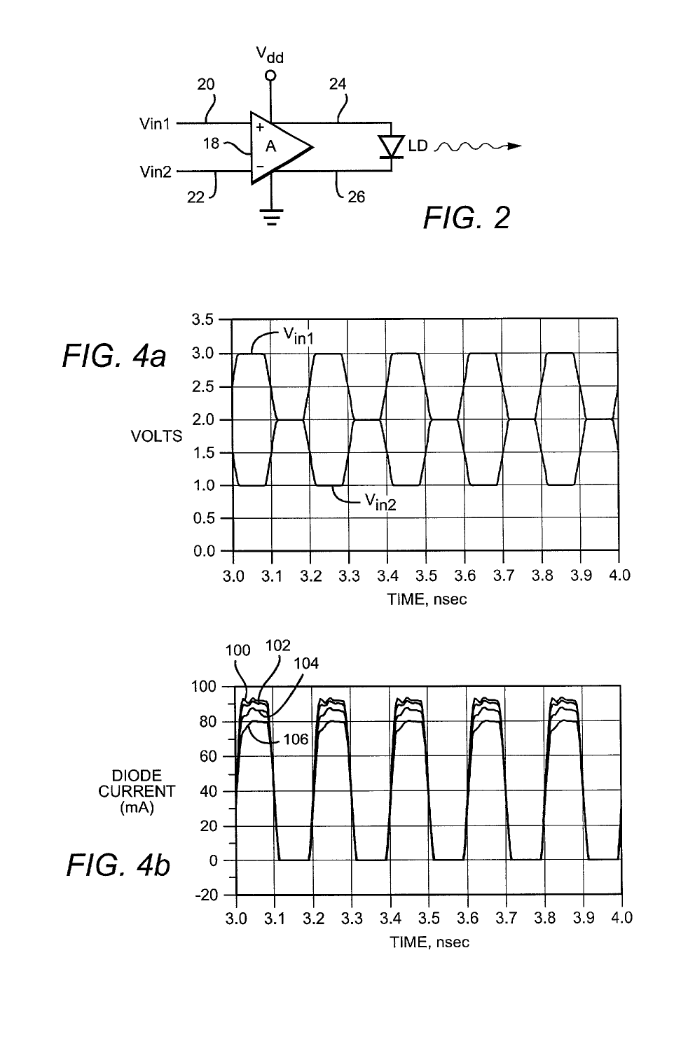

As shown in FIG. 2, the laser diode driver amplifier 18 has inverting and non-inverting inputs (20 and 22) and inverted and non-inverted outputs (24 and 26), arranged to receive a laser diode LD connected between the differential outputs 24 and 26. The amplifier 18 is preferably biased to create an offset voltage between the output branches, to set the operating point of the laser diode LD at a predetermined voltage: for example, it can be maintained at the turn on threshold (for switching applications) or it could alternatively be biased slightly on, in a more linear part of the laser diode's response curve (for applications which demand more linear response).

The economical circuit of FIG. 3 embodies a laser diode driver in accordance with the invention. Differential input signals Vᵢₙ₁ and Vᵢₙ₂ are coupled to respective gates of FETs Q₁ and Q₂, which are arranged in two parallel branches. Bias FET Q₃ provides a bias current which is shared (unequally) by the FETs Q₁ and Q₂. The driven laser diode LD is connected between the branches: i.e., with its anode connected to the source of Q₁ (a first output terminal 28) and its cathode connected to the source of Q₂ (a second output terminal 30) as shown. Thus, the circuit in its simple form includes a differential source follower amplifier, having inverting and non-inverting inputs, inverted and non-inverted outputs (28 and 30), and a load (laser diode) connected between the inverted and non-inverted outputs.

Bias to FETs Q₁ and Q₂ is set by the gate bias voltages of each FET as well as the bias voltage V_{gg1} applied to the gate of Q₃. Preferably, the bias point is set so that the laser diode is “half-biased” near its turn-on threshold—for example, at approximately 1 volt (forward bias) with no input signals applied to Vᵢₙ₁ and Vᵢₙ₂ . This allows the circuit to drive the laser diode with a small input signal and achieve high efficiency and fast switching times.

The circuit operates as follows. When Vᵢₙ=Vᵢₙ₁−Vᵢₙ₂ is high, the diode is switched on and current flows through Q₁, LD and Q₃. When Vᵢₙ is reduced (near zero or negative voltage), the current through Q₁ is switched off and instead diverted to the right hand branch of the circuit through Q₂ and Q₃.

The inductances Lₛₛ₁ and Lₛₛ₂ represent stray inductance associated with the laser diode LD and its circuit pathways. It is advantageous to provide a compensating circuit, preferably a series Resistor-Capacitor circuit to cancel the effects of the stray inductances at the anticipated frequency of operation. Typically (but not necessarily) the laser diode LD will not be integrated on the same chip with the driver circuit, but will instead be separately packaged. In such an arrangement, it has been found that the stray inductances Lₛₛ₁ and Lₛₛ₂ are typically on the order of _{0.2} nanohenries. The compensating resistance and capacitance should be chosen to compensate appropriately. For example, for operation at ₁₀ Ghz, the compensating resistance and capacitances (R_{c1}, R_{c2}, C_{C1} and C_{c2}) can be chosen suitably to introduce a 3 decibel attenuation frequency is placed at approximately 11.5 Gigahertz, to reduce ringing. In practice, values of _{—}5 ohms and 1 picofarad for each resistance R and capacitance have been found to produce desirably clean switching waveforms at a switching frequency of 10 Ghz.

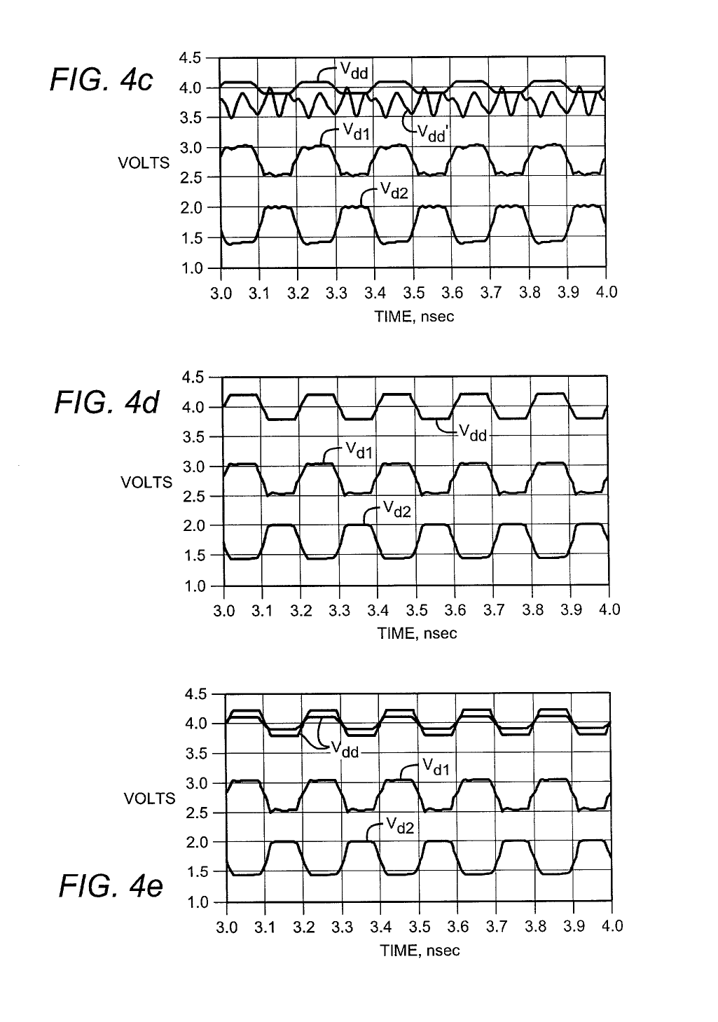

The network of Rₛ₁, Rₛ₂, Lₛ₁ Lₛ₂ and Cₛ has been introduced to simulate characteristics of a real, imperfect voltage source. For simulation purposes, a square wave fluctuation V_{fluc7} has also been added, representing a small square wave fluctuation on top of a DC voltage supply. The supply fluctuations V_{fluc7} typically arise due to coupling with other circuits on or nearby the chip with the circuit in FIG. 3. There may also be independent fluctuations in the supply voltage itself in a typical application. For purposes of simulation (the results of which are discussed below in connection with FIGS. 4a-4e) the following values were assumed: Rₛ₁=0.5 Ohm, Rₛ₂=2.0 Ohm, L_{s1=0.2} nH, Lₛ₂=10 nH, and Cₛ₁=20 nF.

FIG. 4a shows typical drive input pulses as might be applied to Vᵢₙ₁ and Vᵢₙ₂. Vᵢₙ₁ and Vᵢₙ₂ preferably have a DC offset of approximately 0.9 V DC for the off state (of the laser diode). The output current I_{LD} through the laser diode is shown in FIG. 4b, for several values of supply voltage V_{dd}. Curve 100 represents the response with V_{dd}=3.5 V, curve 102 the response for V_{dd}=3.0 V, curve 104 for V_{dd}=2.5 V, and curve 106 represents the response for V_{dd}=2.0 V. For purposes of this analysis, inherent supply inductance Lₛ and supply resistance Rₛ are assumed to be 10,000 nanohenrys and 0.001 Ohm, respectively. These values were chosen to represent realistic assumptions, but actual power supplies will have varying characteristics which will affect performance.

The circuit of FIG. 3 provides excellent rejection of supply voltage fluctuations. FIG. 4c shows a typical case in which voltage V_{dd}′ fluctuates by 0.2 V peak-to-peak from a typical average value. Nevertheless, the voltage across the laser diode LD is not greatly affected by the V_{dd} fluctuation. Waveforms for the respective voltages v_{d1} and v_{d2} at the anode and cathode of the laser diode LD are shown. The voltage across the laser diode LD follows the input waveform, without significant effect from the supply fluctuation, as demonstrated by the figure.

FIG. 4d shows the corresponding response for an increased (induced) power supply voltage fluctuation of 0.4 V. peak-to-peak. Voltages Vd1 and Vd2 show little deviation from the previous figure. The insensitivity to supply fluctuation is further emphasized by FIG. 4e, which simply superimposed the two previous figures. No difference in the responses Vd1 and Vd2 is visible (the waveforms superimpose completely).

In a typical application, laser diode current swings in the range of 80-100 milliamps are obtained without appreciable sensitivity to supply voltage fluctuations, even at very fast switching speeds (up to 10 Ghz).

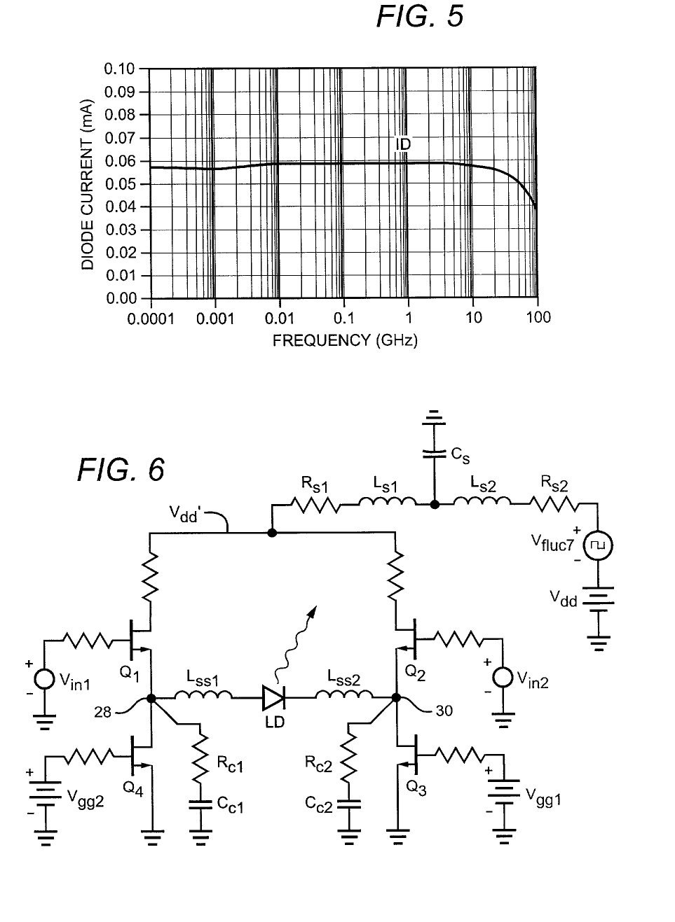

The frequency response of a driver circuit of FIG. 3 is shown in FIG. 5. Flat frequency response is displayed from 100 KHz to 10 GHz, with less than 3 db reduction in response even at frequencies as high as 100 GHz.

The circuit of the invention can most suitably be fabricated with Psuedomorphic High Electron Mobility Transistors (PHEMT) for all the FETs. GaAs is a suitable material for the PHEMTs, and provides fast switching with low supply voltages, thus keeping power consumption low. Low power consumption is also facilitated by the reduced number of transistors as compared to prior art circuits.

An alternate embodiment of the invention is shown in FIG. 6. The alternate embodiment includes the same essential circuit as the circuit of FIG. 3, with an additional FET Q₄ connected between the source of Q1 and ground. The additional FET Q₄ sinks some current from the source of Q₁, in an amount which is determined by the bias voltage (V_{gg2}). This additional FET provides more flexibility in setting the bias point of the laser diode LD, but at the expense of some additional power consumption. Thus, the alternate embodiment of FIG. 6 would be most appropriate in an application in which the laser diode must be biased at a precisely determined turn-on voltage.

It is desirable in either of the above described embodiments that the current bias be provided by a simple single transistor (in the embodiment of FIG. 3) or dual transistor (in the embodiment of FIG. 6). More complex current source bias circuits such as a current mirror should preferably be avoided in order to reduce power consumption and heat generation by the driver circuit.

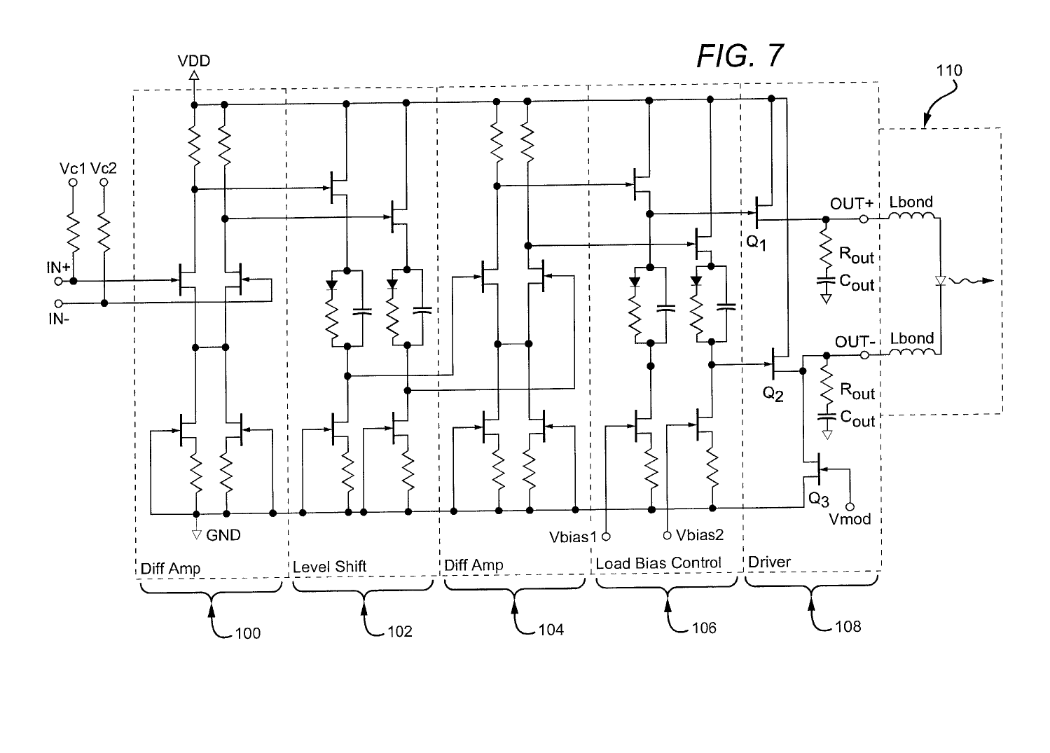

FIG. 7 shows a multistage laser diode driver circuit which incorporates a driver circuit in accordance with one embodiment of the invention (the embodiment discussed above in connection with FIG. 3). FIG. 7 could also be modified to use a driver in accordance with the embodiment of FIG. 6. The circuit is well adapted for driving a laser diode LD at frequencies in the neighborhood of 10 Gigahertz from a supply voltage Vdd of 3.3 Volts. Balanced inputs IN+ and IN− are amplified by differential amplifier stage 100, level shifted by level shifting stage 102 and further amplified by a second differential amplifier stage 104. The amplified and level shifted signal is coupled to a load bias control circuit 106, which offsets the + and − drive signals with respect to one another. The offset is adjustable by the voltages at V_{bias1} and V_{bias2}, and is preferably set to produce driver output at or near the turn on threshold for the laser diode LD, for zero input signal. The driver stage 108 is essentially the circuit discussed above in connection with FIG. 3. Note that the stray inductance L_{bond} is the inductance associated with bond and other wire pathways connecting the (typically external) laser diode LD. The components shown in block 110 are typically external to (not monolithically fabricated with) the driver circuit (100-108).

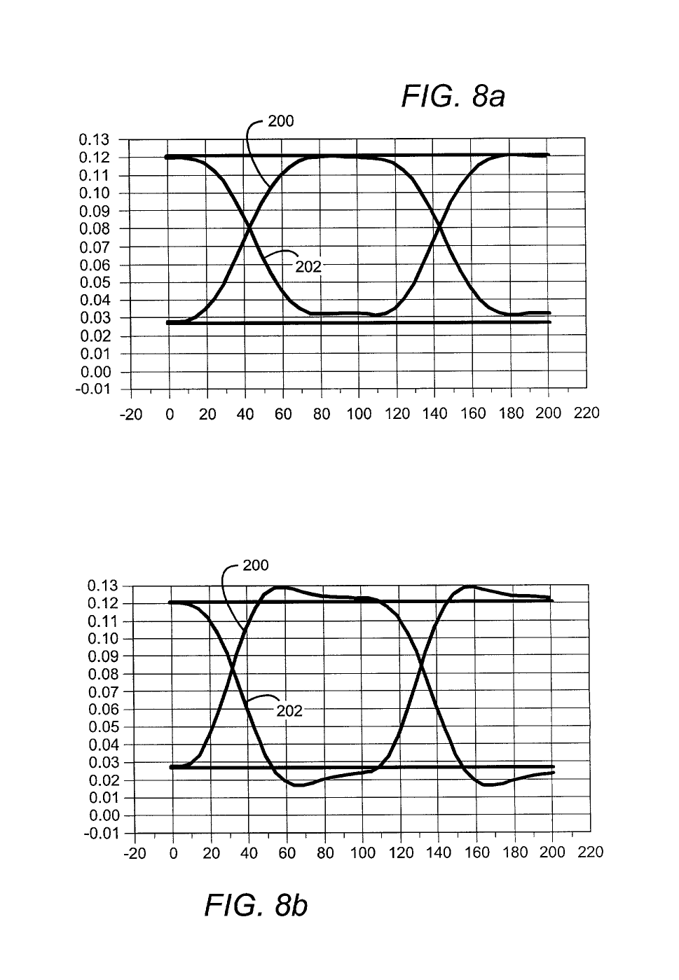

Typical simulated time domain output responses of the circuit of FIG. 7 are shown in FIGS. 8a and 8b (“eye diagrams”) . The outputs show overlaid responses of the circuit when driven by a pseudorandom binary excitation at a 10 Gigabit per second rate. FIG. 8a assumes that the bond inductance in the laser diode branch (external laser diode) is equivalent to two inductors (in series), each with a value of 0.2 nanohenries. Output current in amperes is shown by curves 200 and 202 (phase shifted by one half period). Both rising and falling waveforms are shown superimposed in order to illustrate and emphasize the symmetry of the response. Excellent balance, low overshoot and fast rise time (approximately 30 picoseconds) are apparent. FIG. 8b shows the corresponding outputs where the bond inductance has been assumed to be 0.0 nanohenries. Very slight peak overshoot is seen in curves 200 and 202. In both figures, compensating capacitance Cₒᵤₜ is assumed to be 1 picofarad.

While several illustrative embodiments of the invention have been shown and described, numerous variations and alternate embodiments will occur to those skilled in the art. Differing amounts of additional voltage gain, for example from a common source gain stage, can be incorporated to drive input FETs Q₁ and Q₂ from whatever input voltage levels are available. Bipolar transistors could be partially or completely substituted for the FETs. Transistors and supplies of complementary polarity could be employed to produce an equivalent circuit. Obviously, Vdd could be fixed at a nominal zero or ground potential, and the circuit ground could be biased at a negative potential such as −3.3 volts with respect to Vdd. Such variations and alternate embodiments are contemplated, and can be made without departing from the spirit and scope of the invention as defined in the appended claims.

I claim:

1. A laser diode driver circuit, comprising:
an amplifier having inverting and non-inverting inputs and inverted and non-inverted outputs; and
a laser diode, connected between said inverting and said non-inverting outputs so that said laser diode is driven by the difference between the respective voltages at said inverted and said non-inverted outputs.

2. The driver circuit of claim 1, further comprising:
a biasing circuit, connected to said amplifier, arranged to offset said inverted and non-inverted outputs at a predetermined offset voltage with respect to one another.

3. The laser diode driver circuit of claim 1, wherein said amplifier comprises:
A first branch of said driver circuit, comprising a first amplifier transistor in series with a first biasing transistor, with the source of said first amplifier transistor connected to the drain of said first biasing transistor;
a second branch of said driver circuit, connected in parallel with said first branch, said second branch comprising a second amplifier transistor;
said inverting and non-inverting inputs connected to the respective gates of said first and second amplifier transistors; and
said inverted and non-inverted outputs connected to said sources of said first and second amplifier transistors, respectively.

4. The driver circuit of claim 3, wherein said amplifier transistors are pseudomorphic high electron mobility transistors.

5. The driver circuit of claim 4, wherein said biasing transistor is a pseudomorphic high electron mobility transistor.

6. The driver circuit of claim 3, wherein said biasing transistor together with the gate bias control of the first and second amplifying transistor biases said outputs with an offset, relative to one another, of substantially 1.0 volt, to bias a laser diode substantially at its turn-on threshold.

7. The driver circuit of claim 3, further comprising at least one compensating capacitor coupled to a terminal of said laser diode.

8. A circuit for electrically modulating the drive to a laser diode, suitable for operation in switching mode at frequencies in the Gigahertz region, comprising:
a first transistor, having a gate control terminal, a source terminal and a drain terminal, said first transistor arranged to receive on its control terminal a first input;
a second transistor, having a gate control terminal, a source terminal and a drain terminal, said second transistor arranged to receive on its control terminal a second input;
a first biasing transistor, having a gate control terminal, a source terminal and a drain terminal, having its drain terminal connected to said source terminal of said second transistor;
first and second output terminals, said first output terminal connected to said source terminal of said first transistor, and said second output terminal connected to said source terminal of said second transistor, for driving a laser diode coupled between said output terminals.

9. The circuit of claim 8, further comprising a laser diode coupled between said output terminals.

10. The circuit of claim 8, further comprising a second biasing transistor having a control terminal, a source terminal and a drain terminal, having its drain terminal connected to said source terminal of said first transistor.

11. The circuit of claim 8, wherein said first, second transistor and said first biasing transistor are the only active devices which carries the drive current which also flows through said laser diode.

12. The circuit of claim 8, wherein said first and second transistors are pseudomorphic high electron mobility transistors.

13. The circuit of claim 12, wherein said biasing transistor is also a pseudomorphic high electron mobility transistor.

14. The circuit of claim 8, wherein said first biasing transistor biases said output terminals with an offset, relative to one another, of substantially 1.0 volt, to bias a laser diode substantially at its turn-on threshold.

15. The circuit of claim 8, further comprising at least one compensating capacitor, coupled to an output terminal, to compensate for inductance in the circuit.
